(19) United States
(12) Patent Application Publication
(10) Pub. No.: US 2010/0033801 A1
(43) Pub. Date: Feb. 11, 2010

(54) LIGHT MODULATOR

(75) Inventors: Patrick John Baesjou, Eindhoven (NL); Lucas Josef Maria Schlangen, Eindhoven (NL); Michael Paul Barbara Van Bruggen, Eindhoven (NL); Mark Thomas Johnson, Eindhoven (NL)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 11/993,695

(22) PCT Filed: Jun. 29, 2006
(86) PCT No.: PCT/IB06/52173

§ 371 Date: Dec. 21, 2007

(30) Foreign Application Priority Data
Jul. 7, 2005 (EP) 05106211.5

(51) Int. Cl. G02F 1/167; G09G 3/34; G02F 1/01

(52) U.S. Cl. 359/296; 345/107; 359/290

(57) ABSTRACT

The light modulator (1) for modulating light has a light modulating element (2) and a controller (100,95). For the light modulator (1) to have a stack of at least two differently addressable media, which light modulator (1) can relatively easy be manufactured, the light modulating element (2) has a first and a second medium, each medium extending in a first direction (22) and having a physical state depending on potentials applied to the first and the second medium, and an optical state depending on the physical states. Furthermore, the controller (100,95) is arranged for bringing the first and the second medium in physical states for modulating the light, the controller (100,95) having a configuration of electrodes (95), the configuration extending in the first direction (22); the first medium, the second medium and the configuration of electrodes (95) forming a stack; the electrodes of the configuration (95) being arranged for applying the potentials to the first and the second medium; and decoupling means arranged for decoupling a change in physical state of the first medium from a change in physical state of the second medium in response to the applied potentials.

The invention relates to a light modulator for modulating light.

The invention also relates to a display panel comprising such a light modulator, a display device comprising such a display panel, a billboard comprising such a display panel and a label comprising such a display panel.

The invention further relates to a controller for such a light modulator, and a method for driving such a light modulator.

A light modulator for modulating light is disclosed in US 2002/0171620. The disclosed light modulator is an electrophoretic display panel.

Electrophoretic display panels in general are based on the motion of charged, usually colored particles under the influence of an electric field between electrodes. With these display panels, dark or colored characters can be imaged on a light or colored background, and vice versa. Electrophoretic display panels are therefore notably used in display devices taking over the function of paper, referred to as “paper white” applications, e.g. electronic newspapers and electronic diaries.

The disclosed electrophoretic display panel is a transmissive color display panel incorporated with a backlight and having a plurality of pixels. Each pixel comprises three cells, which are vertically stacked, one directly above the other in the horizontal surface of the panel. The cells contain a light transmissive fluid and charged pigment particles that can absorb a portion of the visible spectrum, with each cell in a stack containing particles having a color different from the color of the particles in the other cell in the stack. The color of a pixel is determined by the portion of the visible spectrum originating from the backlight that survives the cumulative effect of traversing each cell in the stack.

The amount and color of the light transmitted by each cell is controlled by the position and the color of the pigment particles within the cell. The position, in turn is directed by the application of appropriate potentials to a collecting and a counter electrode present in each cell.

The collecting electrodes serve as thin vertical side walls of the pixel oriented perpendicularly to the front window of the panel. Furthermore, the collecting electrodes are vertically aligned. The counter electrodes are also vertically oriented and aligned in the pixel. The counter and collecting electrodes can be formed entirely of electrically conductive metal, such as by electrodeposition into a pattern formed in a layer of photoresist, followed by removal of the photoresist. The collecting electrodes may also be formed as electrically conductive films deposited on the cell-interior surfaces of the nonconductive side walls.

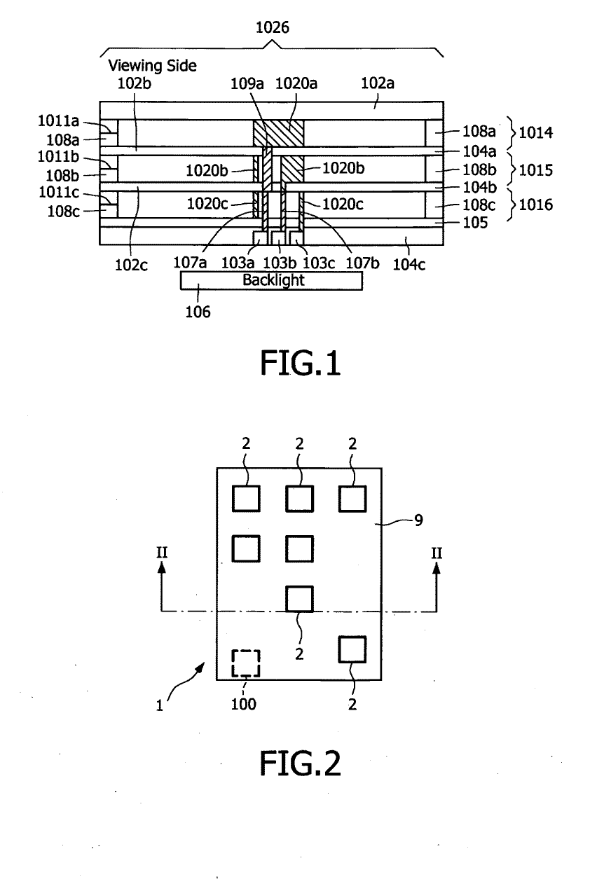

The process of constructing the disclosed electrophoretic display panel can be followed by reference to FIG. 1, a sectional view illustrating the structure of a single pixel 1026 having three stacked color cells.

Each pixel 1026 has three separate driving elements 103a, 103b, and 103c. Driving element 103a is used to operate counter electrode 1020a in cell 1014, driving element 103b is used to operate counter electrode 1020b in cell 1015, and driving element 103c is used to operate counter electrode 1020c in cell 1016.

A transparent insulating film 105, such as of SiO₂, covers the top surface of the rear window 104c of cell 1016, including the driving elements 103a, 103b, and 103c and their associated connections. To make electrical contact between the driving elements and their respective electrodes, common lithographic and etching techniques are used to create properly aligned holes through the insulating film 105.

Standard lithographic, etching, and deposition techniques (for example as described in IBM's U.S. Pat. No. 6,144,361) are used to create the wall electrode 108c, the vertical wires 107a and 107b that reside inside the counter electrode 1020c, and the counter electrode 1020c itself. The counter electrode 1020c is formed directly on the driving element 103c through its contact hole in the insulating layer 105. Vertical wires 107a and 107b are formed directly on the driving elements 103a and 103b respectively, and allow electrical signals originating from their respective driving elements to pass through cell 1016 on their way to counter electrodes 1020a and 1020b, respectively. Plates 102b, 102c have holes that permit the passage of electrical conductors from the driving elements on the surface of the rear panel to the counter electrodes in each of the cells. The holes may be filled with electrically conductive material that serve as the conductors connecting the vertical wires, for example, for the ends of wire 109a that are in contact with the conductive material in the holes of windows 102b, 102c.

The top of cell 1016 is formed by placing a thin transparent plate on the top surfaces of the wall electrode 108c, the counter electrode 1020c, and the vertical wires 107a and 107b.

The next level of construction begins by using lithographic and etching techniques to create holes in the thin plate 102c/104b that expose and allow connection to the vertical wires 107a and 107b. Standard lithographic, etching, and deposition techniques can be used to create the wall electrode 108b, the vertical wire 109a that resides inside the counter electrode 1020b, and the counter electrode 1020b itself. The counter electrode 1020b is formed directly on the vertical wire 107b (that is connected to driving element 103b). Vertical wire 109a is formed directly on vertical wire 107a and allows electrical signals from vertical wire 107a (that originate from driving element 103a) to pass through cell 1015 on their way to counter electrode 1020a.

The top of cell 1015 is formed by placing a thin transparent plate on the top surfaces of the wall electrode 108b, the counter electrode 1020b, and the vertical wire 109a.

The counter electrodes 1020c and 1020b are hollow and thus have passages for electrical connectors, such as the wires 107a, 107b and 109a, which are nested within the electrodes 1020c and 1020b. Nesting wires 107a and 107b inside the hollow counter electrode 1020c, and nesting wire 109a inside the hollow counter electrode 1020b, permit electrical connection to upper counter electrode 1020a while the surrounding electrodes 1020c and 1020b shield the suspension in the lower cells from the electric field generated by the nesting wires 107a and 107b.

The last level of construction begins by using lithographic and etching techniques to create a holes in the thin plate 102b/104a that expose and allow connection to the vertical wire 109a. Standard lithographic, etching, and deposition techniques can be used to create the wall electrode 108a and the counter electrode 1020a. Counter electrode 1020a is formed directly on vertical wire 109a, which is connected to vertical wire 107a, which in turn is connected to driving element 103a.

The top of cell 1014 is formed by placing a thick transparent plate on the top surfaces of the wall electrode 108b and the counter electrode 1020b.

The wall electrodes 108a, 108b, and 108c for every pixel 1026 in the display panel are preferably held at a common voltage, which is preferably ground. To ensure that the three wall electrode structures (one associated with each of the three layers) are held at a common voltage, an electrical connection can be made between the outside edges of the outermost pixels of the display, across the thin transparent plates 102c/104b and 102b/104a. Alternatively, using standard lithographic, etching, and deposition techniques, an electrical connection between the three wall electrode structures could be formed through holes in the thin transparent plates 102c/104b and 102b/104a.

It is a drawback of the disclosed display panel that it is difficult to be manufactured.

It is an object of the invention to provide a light modulator having a stack of at least two differently addressable media, which light modulator can relatively easy be manufactured.

To achieved this object, the invention provides a light modulator for modulating light comprising a light modulating element and a controller, the light modulating element having

a first and a second medium, each medium extending in a first direction and having a physical state depending on potentials applied to the first and the second medium, and

an optical state depending on the physical states,

the controller being arranged for bringing the first and the second medium in physical states for modulating the light, the controller comprising

a configuration of electrodes, the configuration extending in the first direction; the first medium, the second medium and the configuration of electrodes forming a stack; the electrodes of the configuration being arranged for applying the potentials to the first and the second medium; and

decoupling means arranged for decoupling a change in physical state of the first medium from a change in physical state of the second medium in response to the applied potentials.

The inventors have realized that the configuration of electrodes extending in the first direction allows a relatively simple manufacturing process like standard lithographic, etching, and deposition techniques. Therefore, the configuration of electrodes can relatively easy be manufactured. Stacking of the first medium, the second medium and the configuration of electrodes, each extending in the same direction, is also a simple manufacturing process, resulting in a light modulator which can relatively easy be manufactured. Furthermore, the decoupling means reduce or eliminate the coupling of the responses of the first and the second medium to the applied potentials. Consequently, the first and the second medium can be differently addressed. Elimination of the coupling is also denoted as full decoupling.

In an embodiment the decoupling means comprise a physical space being part of the stack and being arranged for causing the first medium and the second medium to experience different applied potentials. Then no additional component is introduced in the light modulator. In an example, the first medium experiences a larger magnitude of the applied potentials than the second medium. In a variation on the embodiment the physical space comprises dielectric material having a dielectric constant for decoupling. Then the difference in experienced applied potentials of the first and the second medium can easily be controlled and the decoupling can easily be improved. In another variation on the embodiment the configuration of electrodes is arranged between the first medium and the second medium. In this manner, both the first and the second medium can be directly controlled from the electrodes, i.e. electric field lines do not have to pass through the first medium to get to the second medium. In another variation on the embodiment the physical space comprises the first medium. Then the arrangement is relatively easily realized. In an example, the first medium is arranged between the second medium and the configuration of electrodes. Then the electrodes can relatively easily be connected to drive electronics. If, furthermore, a dielectric constant of the first medium is larger than 1, preferably larger than 3, then the decoupling is improved. It is furthermore advantageous, if the dielectric constant of the first medium is larger than a dielectric constant of the second medium. This concentrates the electric field lines better in the first medium.

In another embodiment the decoupling means comprise unequal electrical properties of the first medium and the second medium for causing unequal changes in physical states in response to the applied potentials. Then no additional component is introduced in the light modulator. In an example, the first medium changes its physical state quicker than the second medium at identically experienced applied potentials. In another example, the physical state of the first medium has a threshold behavior corresponding to a first threshold in response to the applied potentials, and the physical state of the second medium has a threshold behavior corresponding to a second threshold in response to the applied potentials, the first and the second threshold being unequal. Then the coupling is substantially eliminated. The stack layout may be such that the configuration of electrodes is arranged between the first medium and the second medium. In this manner, both the first and the second medium can be directly controlled from the electrodes.

In another embodiment the configuration of electrodes comprises at least three electrodes and the decoupling means comprise the electrodes of the configuration being arranged for applying the potentials to the first and the second medium, the potentials comprising

first applied potentials for bringing the second medium in a physical state associated with the physical state for modulating the light, and, subsequently

second applied potentials for bringing the first and the second medium in physical states for modulating the light. Then the accuracy of the attained optical state is improved. In a variation on the embodiment the number of electrodes is three. Then relatively simple driving schemes are possible. For a larger number of electrodes, more advanced and therefore more accurate driving is possible. If, furthermore, the electrodes have substantially flat surfaces facing the first and the second medium, then the geometry of the electrodes can be relatively simply manufactured. If, furthermore, the surfaces of the electrodes are present in a substantially flat plane, the manufacturing process of the electrodes is further simplified. The stack layout may be such that the first medium is arranged between the second medium and the configuration of electrodes. Then the electrodes can relatively easily be connected to drive electronics. If, furthermore, the second applied potentials are un-experienced by the second medium, then only the first medium experiences the electrical field generated by the second applied potentials, e.g. the electrical field is confined in the first medium. This confinement can be realized if, e.g. the second applied potentials alternate in sign for subsequent electrodes in the configuration. In another variation on the embodiment application of

the first applied potentials is able to bring the second medium in the physical state for modulating the light, and, subsequently

the second applied potentials is able to bring the first medium in the physical state for modulating the light, the physical state of the second medium being substantially unchanged. Then addressing of the first medium is fully decoupled from addressing of the second medium and the attained optical state is even more accurate.

In another embodiment the light modulating element comprises a reservoir portion substantially non-contributing to the optical state of the light modulating element and an optical active portion substantially contributing to the optical state of the light modulating element. Then the accuracy of the attained optical state is improved. In a variation on the embodiment the reservoir portion comprises one of the electrodes. Then the accuracy of the attained optical state is further improved.

In another embodiment the light modulator further comprises a light source for generating the light to be modulated. Then the light modulator modulates light from a light source for e.g. lighting applications, e.g. a lighting system for lighting a room or a road which has a light output which is adjustable in intensity and/or color and/or direction. Furthermore, if the modulated light is being projected onto a wall or a screen the possibly smooth and detailed patterns inside the light modulating element can be made more visible.

In another embodiment each one of the first and second medium comprises a bi-stable electro-optical effect. Then the power consumption is relatively low. The media can e.g. be written sequentially.

In another embodiment the first medium comprises first charged particles, the second medium comprises second charged particles, the optical state depends on a placement of the first and the second particles as a result of physical movement of the first and the second particles, and the controller is arranged to control the placement of the first and the second particles for modulating the light. In an example, the first medium comprises first charged particles, the second medium comprises second charged particles, the optical state depends on an orientation of the first and the second particles, and the controller is arranged to control the orientation of the first and the second particles for modulating the light. This is e.g. a twisting ball light modulator or a suspended particle light modulator having small A1 plates which can be oriented. It is clear that preceding embodiments of the light modulator can be embodied in a twisting ball light modulator or a suspended particle light modulator. An example of a twisting ball light modulator is a twisting ball display panel (Gyricon). Such a display panel has good paper-like/white display properties. In another example, the first medium comprises a first electrophoretic medium comprising first charged particles, the second medium comprises a second electrophoretic medium comprising second charged particles, the optical state depends on a position of the first and the second particles, and the controller is arranged to control the position of the first and the second particles for modulating the light. This is e.g. an electrophoretic light modulator. It is clear that preceding embodiments of the light modulator can be embodied in an electrophoretic light modulator. An example of an electrophoretic light modulator is an electrophoretic display panel. Such a display panel has even better paper-like/white display properties. Apart from electronic reading applications like electronic-book (e-book), e-magazine and e-newspapers, electrophoretic display panels can form the basis of a variety of applications where information may be displayed, for example in the form of information signs, public transport signs, advertising posters, pricing labels, shelf labels, billboards etc. In addition, they may be used where a changing non-information surface is required, such as wallpaper with a changing pattern or colour, especially if the surface requires a paper like appearance. In a variation on the embodiment the first and the second electrophoretic medium are separated by a separation layer. Then a wide variety of electrophoretic media can be used. If, however, the first and the second electrophoretic medium are in contact and are immiscible, then the separation layer can be omitted. If the first electrophoretic medium comprises a first solvent and the second electrophoretic medium comprises a second solvent, the first solvent and the second solvent being immiscible, then the media being immiscible is relatively easily realized. In an example, the first solvent is an apolar organic solvent and the second solvent is a fluorinated organic solvent, e.g. the first and the second solvent are dodecane and FC-40, respectively. In a variation on the embodiment at least one of the first and the second electrophoretic medium comprises a surface active agent for lowering the surface energy where the first and the second medium are in contact. Then the first and the second medium are prevented from displacing one another.

Another aspect of the invention provides a display panel for displaying a picture comprising the light modulator as claimed in claim 1. In an embodiment the display panel has a mode of operation being transmissive. In another embodiment the display panel has a mode of operation being reflective, reducing the power consumption.

Another aspect of the invention provides a display device comprising the display panel as claimed in claim 33 and a circuitry to provide image information to the display panel.

Another aspect of the invention provides a billboard for displaying advertisement information comprising the display panel as claimed in claim 33.

Another aspect of the invention provides a label for displaying information comprising the display panel as claimed in claim 33.

Another aspect of the invention provides a controller for a light modulator, the light modulator for modulating light comprising a light modulating element having

a first and a second medium, each medium extending in a first direction and having a physical state depending on potentials applied to the first and the second medium, and

an optical state depending on the physical states,

the controller being arranged for bringing the first and the second medium in physical states for modulating the light, the controller comprising

a configuration of electrodes, the configuration extending in the first direction; the first medium, the second medium and the configuration of electrodes forming a stack; the electrodes of the configuration being arranged for applying the potentials to the first and the second medium; and

decoupling means arranged for decoupling a change in physical state of the first medium from a change in physical state of the second medium in response to the applied potentials.

Another aspect of the invention provides a method for driving a light modulator, the light modulator for modulating light comprising a light modulating element having

a first and a second medium, each medium extending in a first direction and having a physical state depending on potentials applied to the first and the second medium, and

an optical state depending on the physical states,

the light modulator comprising

a configuration of electrodes, the configuration extending in the first direction; the first medium, the second medium and the configuration of electrodes forming a stack; the electrodes of the configuration being arranged for applying the potentials to the first and the second medium; and

decoupling means arranged for decoupling a change in physical state of the first medium from a change in physical state of the second medium in response to the applied potentials,

the method comprising the step of bringing the first and the second medium in physical states for modulating the light.

The mere fact that certain measures are mentioned in different claims does not indicate that a combination of these measures cannot be used to advantage.

These and other aspects of the light modulator of the invention will be further elucidated and described with reference to the drawings, in which:

FIG. 1 shows diagrammatically a sectional view of a prior art electrophoretic display panel illustrating the structure of a single pixel having three stacked color cells;

FIG. 2 shows diagrammatically a front view of an embodiment of a display panel according to the invention;

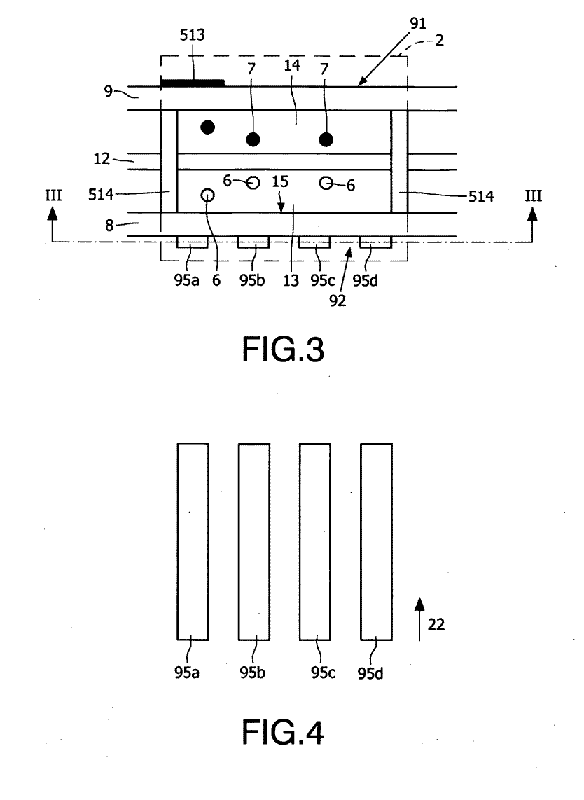

FIG. 3 shows diagrammatically a cross-sectional view along II-II in FIG. 2, the cross-sectional view representing a layout of the pixel;

FIG. 4 shows diagrammatically a cross-sectional view along III-III in FIG. 3;

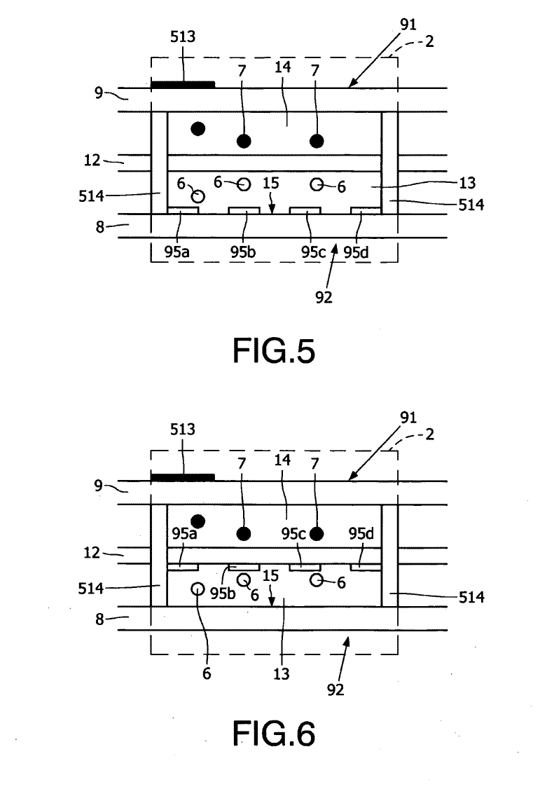

FIGS. 5, 6, 7, 8 and 9 show diagrammatically other layouts of the pixel;

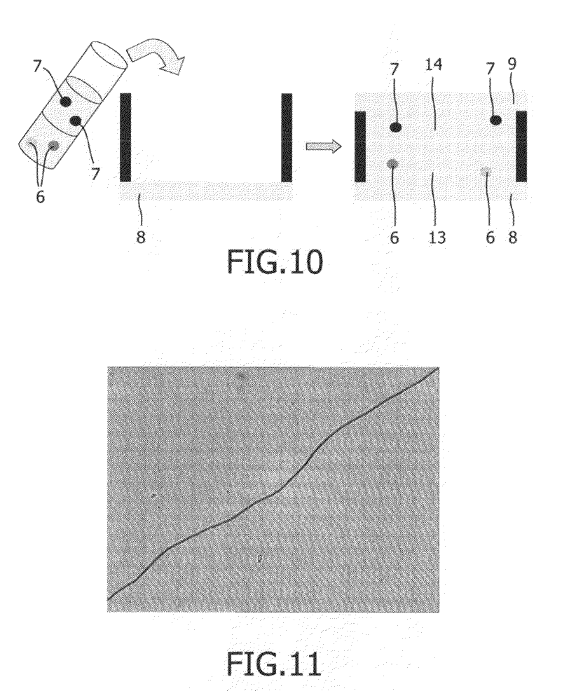

FIG. 10 shows the filling of a display panel with a double suspension in a single step; the two suspensions do not mix, forming an inherently stacked display panel;

FIG. 11 shows a photo of a detail of the boundary between a suspension of carbon black in a fluorocarbon solvent and a suspension of a magenta pigment in dodecane; no transfer of particles from one fluid to the other is observed;

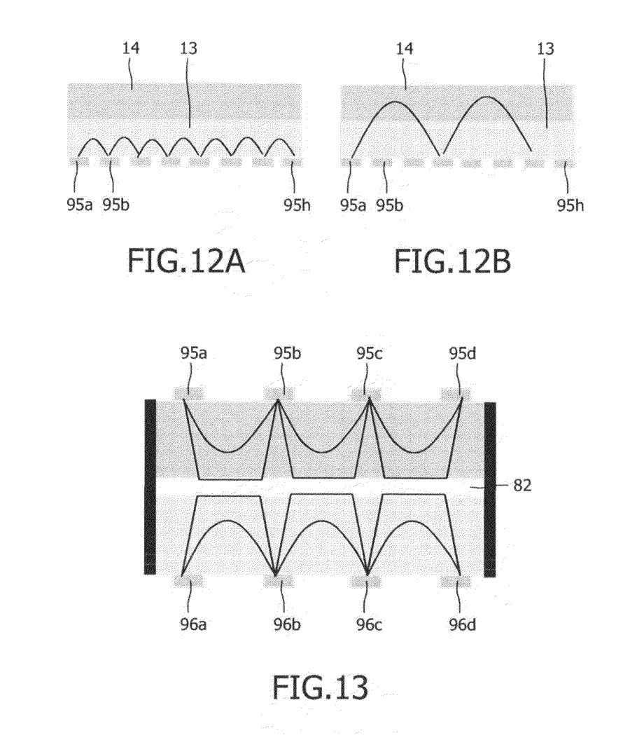

FIGS. 12A and 12B show possible driving setup for a two-layer pixel, using one active plate: (a) driving all electrodes (alternating + and −) to confine the electric field to the bottom fluid layer (FIG. 12A); (b) driving fewer electrodes to extend the electric field also into the top fluid layer (FIG. 12B); and

FIG. 13 shows a schematic representation of the electric field lines within a pixel with three immiscible fluid layers stacked on one another and two active plates; the 3^{rd} liquid is transparent for visible light and has a high dielectric constant.

In all the Figures corresponding parts are referenced to by the same reference numerals.

FIGS. 2-4 show an example of a light modulator in the form of a display panel 1 having a first substrate 8, a second transparent opposed substrate 9 and a plurality of light modulating elements 2, being pixels 2. Preferably, the pixels 2 are arranged along substantially straight lines in a two-dimensional structure. Other arrangements of the pixels 2 are possible, e.g. a honeycomb arrangement. In an active matrix embodiment, the pixels 2 may further comprise switching electronics, for example, thin film transistors (TFTs), diodes, MIM devices or the like.

Each pixel 2 has a first and a second medium, each medium extending in a first direction 22 and having a physical state depending on potentials applied to the first and the second medium, and an optical state depending on the physical states. Furthermore, the controller 100,95 is arranged for bringing the first and the second medium in physical states for modulating the light for displaying a picture. The controller 100,95 has a configuration of electrodes and decoupling means. The configuration of electrodes 95 extends in the first direction 22. Furthermore, the first medium, the second medium and the configuration of electrodes 95 form a stack and the electrodes of the configuration 95 are arranged for applying the potentials to the first and the second medium. The decoupling means are arranged for decoupling a change in physical state of the first medium from a change in physical state of the second medium in response to the applied potentials. The decoupling means comprise a physical space being part of the stack and being arranged for causing the first medium and the second medium to experience different applied potentials. The decoupling means comprise the first medium.

The display panel 1 of FIGS. 2-4 is an electrophoretic display panel. The first medium comprises a first electrophoretic medium having first charged particles 6 in a transparent fluid. The second medium comprises a second electrophoretic medium having second charged particles 7 in a transparent fluid. Both media are present between the substrates 8,9. Electrophoretic media are known per se from e.g. US 2002/0180688. The first charged particles 6 have a first optical property. The second charged particles 7 have a second optical property different from the first optical property. The first particles 6 may have any color, whereas the second particles 7 may have any color different from the color of the first particles 6. The first and second particles 6,7 may have subtractive primary colors, e.g. the first particles 6 being cyan and the second particles 7 being magenta. Other examples of the color of the first particles 6 are for instance red, green, blue, yellow, cyan, magenta, white or black. The particles may be large enough to scatter light, or small enough to substantially not scatter light. In the examples the latter is the case. The first particles 6 are able to occupy positions in the first cell 13 of the pixel 2, and the second particles 7 are able to occupy positions in the second cell 14 of the pixel 2. The first and the second cell 13,14 are vertically stacked and separated by a transparent layer or substrate 12. The optical state of a pixel 2 depends on the positions of the particles 6,7 in the pixel 2.

In this setup, it can be beneficial to combine the pixel 2 with a (complementary) color filter, e.g. cyan and magenta particles with a yellow color filter, as described in patent application WO2005/040908.

It is also possible that each medium contains more than one type of charged particle, preferably two, with different optical properties. In that case, the different types of particles should have clearly different electrophoretic properties, to allow control over the movement of the different particles. This means that the different particles should have clearly different charges, either in sign or in magnitude. With two layers, four different particles can be used. For example: magenta and yellow in the first medium/layer, and cyan and black in the second medium/layer. In this way, a full-color display can be realized without the need for an additional color filter.

The configuration of electrodes 95 extends in the first direction 22 (see FIG. 4). The electrodes 95 are able to receive potentials from drive means 100. Furthermore, the drive means are arranged to control the potentials for controlling the position of the first and the second particles 6,7 for modulating the light for displaying the picture. Also the first and the second medium extend in the first direction 22.

The surface 15 of the first substrate 8 facing the second substrate 9 may be reflective or have any color. Substrate 8 may even be transparent if the panel 1 is used in light transmissive mode. The pixel 2 has a light outcoupling surface 91, also denoted as viewing surface 91, for coupling out the modulated light. Furthermore, the barriers 514 forming pixel walls separate the pixel 2 from its environment. The region in cell 13 near the surface of electrode 95a provides a reservoir for the particles 6 and the region in cell 14 near the surface of electrode 95a provides a reservoir for the particles 7. The reservoirs are substantially non-contributing to the optical state of the pixel 2. This is achieved by a black matrix layer 513 between electrode 95a and the observer. Electrodes 95b-95d are in the optically active portion of the pixel 2.

In transmissive mode, the optical state of the pixel 2 is determined by the portion of the visible spectrum incident on the pixel 2 at the side 92 of the first substrate 8 that survives the cumulative effect of traversing through the configuration of electrodes 95, the first substrate 8, cell 13, layer 12, cell 14 and the second substrate 9. Then, preferably, the electrodes 95 are transparent. In reflective mode, the optical state of the pixel 2 is determined by the portion of the visible spectrum incident on the pixel 2 at the side of the second substrate 9 that survives the cumulative effect of traversing through the second substrate 9, cell 14, layer 12, cell 13, subsequently interacting with surface 15 of the first substrate 8 which may be reflective or have any color and subsequently traversing back through cell 13, layer 12, cell 14 and the second substrate 9. Furthermore, the amount and color of the light transmitted by each cell 13,14 is controlled by the position and the color of the particles 6,7 within the cell 13,14. When the particles are positioned in the path of the light that enters the cell, the particles absorb a selected portion of the light and the remaining light is transmitted through the cell. When the particles are substantially removed from the path of the light entering the cell, the light can pass through the cell and emerge without significant visible change. The light seen by the viewer, therefore, depends on the distribution of particles 6,7 in each of the cells 13,14 in the vertical stack.

In an example, consider the first and the second particles 6,7 to be negatively charged and the first particles 6 to have a cyan color (by absorbing red light) and the second particles 7 to have a magenta color (by absorbing green light). Furthermore, the surface 15 of the first substrate 8 is white. Furthermore, consider the pixel layout of FIG. 3 and the optical state of the pixel 2 for displaying the picture to be cyan.

To obtain this optical state, firstly, the magenta particles 7 are brought in their collected state in a region in cell 14 near the surface of electrode 95a by appropriately changing the potentials received by the electrodes 95a-95d, e.g. electrodes 95a-95d receive potentials of 15 Volts, 10 Volts, 5 Volts and 0 Volts, respectively. Note that potentials of 15 Volts, 0 Volts, 0 Volts and 0 Volts could alternatively be applied. Subsequently, the cyan particles 6 are brought in their distributed state in cell 13 by appropriately changing the potentials received by the electrodes 95a-95d, e.g. electrodes 95a-95d receive potentials of 0 Volts, 3 Volts, 3 Volts and 3 Volts, respectively. The magenta particles 7 are substantially immobile as the perceived electric field is substantially zero because of the relative large distance between the particles 7 and the electrodes 95 and the relative low potentials. As a result, the magenta particles 7 are substantially removed from the path of the light entering the cell and the light can pass through the cell without significant visible change. As, furthermore, the cyan particles 6 are present in the path of the light that enters the cell, the optical state of the pixel 2 is cyan.

Note that the pixel 2 has at least four achievable optical states: cyan, magenta, white and blue. To obtain an optical state being magenta, firstly, the magenta particles 7 are brought in their distributed state in cell 14 by appropriately changing the potentials received by the electrodes 95a-95d. Subsequently the cyan particles 6 are brought in their collected state near the surface of electrode 95a, by appropriately changing the potentials received by the electrodes 95a-95d. During the latter transition, the magenta particles 7 are substantially immobile.

To obtain an optical state being white, the cyan and magenta particles 6,7 are brought in their respective collected states by appropriately changing the potentials received by the electrodes 95a-95d.

The optical state is blue when both the cyan and the magenta particles 6,7 are in their distributed state in cell 13,14.

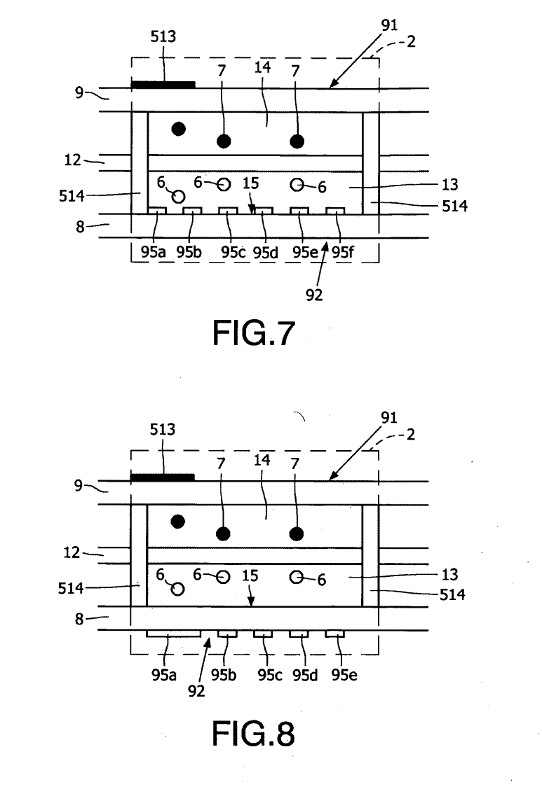

Many other layouts of the pixel 2 are possible; see e.g. the layouts shown in FIGS. 5-8. In FIG. 5 the configuration of electrodes 95 is present on the side of the first substrate 8 facing the first and the second medium. The decoupling means comprise a physical space being part of the stack and being arranged for causing the first medium and the second medium to experience different applied potentials. The decoupling means comprise the first medium. In FIG. 6 the configuration of electrodes 95 is present on layer 12. The decoupling means comprise a physical space being part of the stack and being arranged for causing the first medium and the second medium to experience different applied potentials. The physical space comprises separation layer 12 having a dielectric constant for decoupling. In FIG. 7 the configuration of electrodes 95 consists of 6 electrodes being present on the side of the first substrate 8 facing the first and the second medium. The decoupling means comprise the first medium. In FIG. 8 the configuration of electrodes 95 consists of 5 electrodes being present on the side of the first substrate 8 facing away from the first and the second medium. Here electrode 95a is larger than electrodes 95b-95e. The decoupling means comprise the first medium.

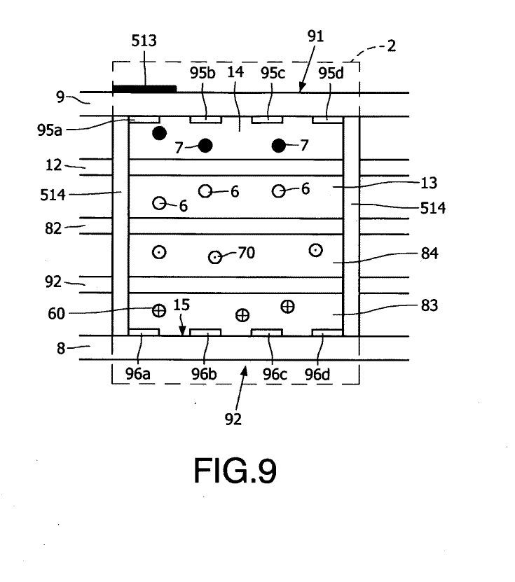

FIG. 9 shows another embodiment of the display panel 1. The pixel 2 has a cell 13 comprising a first electrophoretic medium having first charged particles 6 in a transparent fluid. The pixel 2 has a cell 14 comprising a second electrophoretic medium having second charged particles 7 in a transparent fluid. The pixel 2 has a cell 83 comprising a third electrophoretic medium having third charged particles 60 in a transparent fluid. The pixel 2 has a cell 84 comprising a fourth electrophoretic medium having fourth charged particles 70 in a transparent fluid. The cells 13,14,83,84 are stacked. The first, the second, the third and the fourth particles 6,7,60,70 have mutually dissimilar optical properties.

The controller has a configuration of electrodes 95 receiving potentials from drive means 100 for controlling the position of the first and the second particles 6,7 and the controller has a configuration of electrodes 96 receiving potentials from drive means 100 for controlling the position of the third and the fourth particles 60,70. The optical state depends on the position of the first, the second, the third and the fourth particles 6,7,60,70 in the pixel 2.

Layers 12,82,92 are present for separating media from each other. Layer 82 may furthermore have a large dielectric constant for decoupling cell 13 and 14 from cell 83 and 84. It is even more effective if the layer 82 has a high electrical resistance, e.g. a layer of glass.

Consider the first particles 6 to be positively charged and to have a yellow color in transmission, the second particles 7 to be positively charged and to have a cyan color in transmission, the third particles 60 to be negatively charged and to have a magenta color in transmission, and the fourth particles 70 to be negatively charged and to have a black color.

Electrodes 95a and 96a are part of the reservoir substantially non-contributing to the optical state of the pixel 2. The other electrodes 95b-95d,96b-96d are in the optical active portion.

In the embodiment of FIG. 9 the position of the particles 6,7,60,70 in the optical active portions determine the optical state of the pixel 2. Consider light to enter the pixel 2 at the side 92 of the first substrate 8, e.g. from a (not drawn) backlight source, and to exit out of the pixel 2 via the viewing surface 91.

The pixel 2 can achieve at least the following favorable optical states: anyone of the three subtractive primary colors (yellow, cyan, magenta), anyone of the three primary colors (the optical state of the pixel is green when only the cyan and yellow particles are in the optical active portion; the optical state of the pixel is blue when only the magenta and cyan particles are in the optical active portion; the optical state of the pixel is red when only the magenta and yellow particles are in the optical active portion), black and white.

Furthermore, different intensity levels of the first and the second particles 6,7 can be obtained by tuning the values of the potentials applied to the electrodes 95a-95d, and different intensity levels of the third and the fourth particles 60,70 can be obtained by tuning the values of the potentials applied to the electrodes 96a-96d. In this way a 4 particle electrophoretic pixel 2 is envisaged with an electric sorting mechanism using 2 configurations of electrodes.

The transparent separation layer 12 in e.g. FIG. 3 (or layers 12, 82, 92 in FIG. 9) may result in parallax, i.e. viewing angle dependence of the color. The separation layer 12 can be removed by preparing the two different electrophoretic dispersions in solvents that are immiscible with one another. Then, the pixels 2 can be filled in one step with both suspensions, resulting in two separate fluid layers without the need for a separation layer. This is schematically shown in FIG. 10. The two fluids should be immiscible, and should be non-conductive and electrochemically stable. A possible combination is for one fluid to be an apolar organic solvent, e.g. dodecane, and the other a fluorinated organic solvent, e.g. FC-40. Experiments have shown that it is possible to have the two suspensions in close contact without pigment transfer from one fluid to the other (see for example FIG. 11). Even after vigorous shaking the two fluid layers will phase separate neatly. So, the pixel 2 may be filled subsequently with the separate fluids, or filled with an emulsion of the two fluids in one another, that will then phase separate. The first option is preferred, as it is most likely to give the best results.

To prevent the fluid layers from displacing one another, it may be necessary to coat one or both substrates 8,9 with a coating that has a high affinity for the fluid intended to be in contact with that substrate. Furthermore, it can be beneficial to add a surface active agent to one or both fluids, to minimize the surface energy where the two fluids are in contact, while not being so surface active that it will promote emulsification of the two fluids in one another. Both additions may be required to keep both fluids in their intended positions, and not have, for example, differences in density dominating the fluid distributions when the display is tilted.

Alternatively, it is possible to in situ grow a separation layer between the two media, to improve the physical stability of the system and prevent the different media from displacing each other upon tilting, mixing and/or emulsifying. This may be achieved by several in situ polymerization techniques. One possible, non-limiting, embodiment would be to make use of a 2-component polymerization technique that requires a combination of two different monomers. By dissolving one of the monomers in the first medium, and the second monomer in the second medium, polymerization will only occur at the boundary between the two media. This way, a thin polymer layer is grown between the two media. This will help to stabilize the display, without issues such as parallax and light leakage related to a transparent layer 12 as depicted in FIG. 3.

Driving of such a 2-layer setup may be done from one active plate as schematically shown in FIG. 12. When using the (in-plane) electrode configuration 95 with a sufficiently small gap between the electrodes, preferably equal to or smaller than the thickness of the first fluid layer, the electric fields generated will be largely confined to that first fluid layer. When only addressing electrodes further apart, the electric field will also extend into the second layer, thereby manipulating the particles 6,7 in both layers. This second case may be achieved by grouping electrodes (shorting them with their neighbors), applying zero or intermediate voltages to the ‘unused’ electrodes, or have them floating.

These two driving schemes can then be executed in an alternate fashion. First, the particles 6,7 can be moved in both layers (FIG. 12B) to get the particles 7 in the top layer to the required location. Then, particles 6 in the bottom layer only can be moved (FIG. 12A) to get those to their required locations, without influencing the particles 7 in the top layer. In this manner, effectively the entire display panel 1 can be driven from a single active plate.

The option of minimizing stray fields in the embodiment shown in FIG. 9 comes at the cost in design freedom. Electrodes will have to be placed within a relatively small distance from one another. It may well be that this is not the optimal electrode geometry. Another option to overcome stray electric fields is to choose the layer 82 to be a thin layer of a transparent fluid with a suitably high dielectric constant, that is immiscible with the electrophoretic media in cell 13 and cell 84. One option for this fluid is water. This third fluid may then be sandwiched in between the other two liquids, and serve as a ‘shielding’ layer for the stray fields from the active plates. This will prevent those stray fields from extending into the fluid layer they are not intended for. This is schematically shown in FIG. 13.

Many other display principles are possible. An example is a rotating ball display panel, such as the “SmartPaper” display panel from Gyricon. Another example is an electrowetting display, such as the display from Philips, see B. J. Feenstra, R. A. Hayes and M. W. J. Prins, Display Device, PCT—Application WO 03/00196. Driving is straightforward, if the electrowetting display is a bi-stable display. If the electrowetting display is not a bi-stable display then there is the option to drive either the lowest voltage layer, or to simultaneously drive both layers.

1. A light modulator for modulating light comprising a light modulating element and a controller, the light modulating element having
a first and a second medium, each medium extending in a first direction and having a physical state depending on potentials applied to the first and the second medium, and
an optical state depending on the physical states,
the controller being arranged for bringing the first and the second medium in physical states for modulating the light, the controller comprising
a configuration of electrodes, the configuration extending in the first direction; the first medium, the second medium and the configuration of electrodes forming a stack; the electrodes of the configuration being arranged for applying the potentials to the first and the second medium; and
decoupling means arranged for decoupling a change in physical state of the first medium from a change in physical state of the second medium in response to the applied potentials.

2. A light modulator as claimed in claim 1 characterized in that the decoupling means comprise a physical space being part of the stack and being arranged for causing the first medium and the second medium to experience different applied potentials.

3. A light modulator as claimed in claim 2 characterized in that the physical space comprises dielectric material having a dielectric constant for decoupling.

4. A light modulator as claimed in claim 2 or 3 characterized in that the configuration of electrodes is arranged between the first medium and the second medium.

5. A light modulator as claimed in claim 2 characterized in that the physical space comprises the first medium.

6. A light modulator as claimed in claim 5 characterized in that the first medium is arranged between the second medium and the configuration of electrodes.

7. A light modulator as claimed in claim 6 characterized in that a dielectric constant of the first medium is larger than 1, preferably larger than 3.

8. A light modulator as claimed in claim 7 characterized in that the dielectric constant of the first medium is larger than a dielectric constant of the second medium.

9. A light modulator as claimed in claim 1 characterized in that the decoupling means comprise unequal electrical properties of the first medium and the second medium for causing unequal changes in physical states in response to the applied potentials.

10. A light modulator as claimed in claim 9 characterized in that the physical state of the first medium has a threshold behavior corresponding to a first threshold in response to the applied potentials, and the physical state of the second medium has a threshold behavior corresponding to a second threshold in response to the applied potentials, the first and the second threshold being unequal.

11. A light modulator as claimed in claim 9 characterized in that the configuration of electrodes is arranged between the first medium and the second medium.

12. A light modulator as claimed in claim 2 characterized in that the configuration of electrodes comprises at least three electrodes and the decoupling means comprise the electrodes of the configuration being arranged for applying the potentials to the first and the second medium, the potentials comprising
first applied potentials for bringing the second medium in a physical state associated with the physical state for modulating the light, and, subsequently
second applied potentials for bringing the first and the second medium in physical states for modulating the light.

13. A light modulator as claimed in claim 12 characterized in that the number of electrodes is three.

14. A light modulator as claimed in claim 12 characterized in that the electrodes have substantially flat surfaces facing the first and the second medium.

15. A light modulator as claimed in claim 14 characterized in that the surfaces of the electrodes are present in a substantially flat plane.

16. A light modulator as claimed in claim 12 characterized in that the first medium is arranged between the second medium and the configuration of electrodes.

17. A light modulator as claimed in claim 16 characterized in that the second applied potentials are un-experienced by the second medium.

18. A light modulator as claimed in claim 17 characterized in that the second applied potentials alternate in sign for subsequent electrodes in the configuration.

19. A light modulator as claimed in claim 12 characterized in that application of
the first applied potentials is able to bring the second medium in the physical state for modulating the light, and, subsequently
the second applied potentials is able to bring the first medium in the physical state for modulating the light, the physical state of the second medium being substantially unchanged.

20. A light modulator as claimed in claim 1 characterized in that the light modulating element comprises a reservoir portion substantially non-contributing to the optical state of the light modulating element and an optical active portion substantially contributing to the optical state of the light modulating element.

21. A light modulator as claimed in claim 20 characterized in that the reservoir portion comprises one of the electrodes.

22. A light modulator as claimed in claim 1 characterized in that the light modulator further comprises a light source for generating the light to be modulated.

23. A light modulator as claimed in claim 22 characterized in that the modulated light is being projected onto a wall or a screen.

24. A light modulator as claimed in claim 1 characterized in that each one of the first and second medium comprises a bi-stable electro-optical effect.

25. A light modulator as claimed in claim 1 characterized in that the first medium comprises first charged particles, the second medium comprises second charged particles, the optical state depends on a placement of the first and the second particles as a result of physical movement of the first and the second particles, and the controller is arranged to control the placement of the first and the second particles for modulating the light.

26. A light modulator as claimed in claim 25 characterized in that the first medium comprises first charged particles, the second medium comprises second charged particles, the optical state depends on an orientation of the first and the second particles, and the controller is arranged to control the orientation of the first and the second particles for modulating the light.

27. A light modulator as claimed in claim 25 characterized in that the first medium comprises a first electrophoretic medium comprising first charged particles, the second medium comprises a second electrophoretic medium comprising second charged particles, the optical state depends on a position of the first and the second particles, and the controller is arranged to control the position of the first and the second particles for modulating the light.

28. A light modulator as claimed in claim 27 characterized in that the first and the second electrophoretic medium are separated by a separation layer.

29. A light modulator as claimed in claim 27 characterized in that the first and the second electrophoretic medium are in contact and are immiscible.

30. A light modulator as claimed in claim 29 characterized in that the first electrophoretic medium comprises a first solvent and the second electrophoretic medium comprises a second solvent, the first solvent and the second solvent being immiscible.

31. A light modulator as claimed in claim 30 characterized in that the first solvent is an apolar organic solvent and the second solvent is a fluorinated organic solvent.

32. A light modulator as claimed in claim 30 characterized in that at least one of the first and the second electrophoretic medium comprises a surface active agent for lowering the surface energy where the first and the second medium are in contact.

33. A display panel for displaying a picture comprising the light modulator as claimed in claim 1.

34. A display panel as claimed in claim 33 characterized in that the display panel has a mode of operation being transmissive.

35. A display panel as claimed in claim 33 characterized in that the display panel has a mode of operation being reflective.

36. A display device comprising the display panel as claimed in claim 33 and a circuitry to provide image information to the display panel.

37. A billboard for displaying advertisement information comprising the display panel as claimed in claim 33.

38. A label for displaying information comprising the display panel as claimed in claim 33.

39. A controller for a light modulator, the light modulator for modulating light comprising a light modulating element having
a first and a second medium, each medium extending in a first direction and having a physical state depending on potentials applied to the first and the second medium, and
an optical state depending on the physical states,
the controller being arranged for bringing the first and the second medium in physical states for modulating the light, the controller comprising
a configuration of electrodes, the configuration extending in the first direction; the first medium, the second medium and the configuration of electrodes forming a stack; the electrodes of the configuration being arranged for applying the potentials to the first and the second medium; and
decoupling means arranged for decoupling a change in physical state of the first medium from a change in physical state of the second medium in response to the applied potentials.

40. A method for driving a light modulator, the light modulator for modulating light comprising a light modulating element having
a first and a second medium, each medium extending in a first direction and having a physical state depending on potentials applied to the first and the second medium, and
an optical state depending on the physical states,
the light modulator comprising
a configuration of electrodes, the configuration extending in the first direction; the first medium, the second medium and the configuration of electrodes forming a stack; the electrodes of the configuration being arranged for applying the potentials to the first and the second medium; and
decoupling means arranged for decoupling a change in physical state of the first medium from a change in physical state of the second medium in response to the applied potentials,
the method comprising the step of bringing the first and the second medium in physical states for modulating the light.
